(19) United States
(12) Patent Application Publication
(10) Pub. No.: US 2009/0113723 A1
(43) Pub. Date: May 7, 2009

(54) Safety device for garden pruners

(76) Inventors: Cheng-Yao Kao, Taichung City (TW); Hui-Ling Tsao, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/979,373

(22) Filed: Nov. 2, 2007

(51) Int. Cl. B26B 13/00

(52) U.S. Cl. 30/262

(57) ABSTRACT

A pair of pruners include a first handle with a first function member connected to a first end of the first handle. A first connection member is connected to an inside of the first handle and an end head is connected to a distal end of the first connection member. A second handle with a second function member connected to a first end of the second handle. The first and second handles are pivotably connected to each other. A second connection member is connected to an inside of the second handle and includes an outer threaded section. A collar is rotatably mounted to the first connection member and removably and threadedly connected to the outer threaded section of the second connection member.

### FIELD OF THE INVENTION

The present invention relates to a safety device for positioning two handles of garden pruners.

### BACKGROUND OF THE INVENTION

A pair of conventional garden pruners is disclosed in FIG. 5C and generally includes two handles which are pivotably connected to each other, each handle is connected with a cutting member at one end thereof. A safety device 6 is connected between the two handles so as to keep the two handles to a closed position when the pruners are not in use. The safety device 6 includes a locking plate 62 having a hole 622 defined through a first end thereof and a circular flange extends from a first side of the locking plate 62 and encloses the hole 622. A flange 621 extends inward from an inner periphery of the circular flange and a notch 623 is defined in the inner periphery of the circular flange. Two pins 61 respectively connected on the two handles and each include a head and a shank from which two protrusions 611 extend, two gaps 612 are defined between the two protrusions 611 and an underside of the head. A spring 64 is engaged with the inner periphery of the circular flange and includes two legs 641, 642 which are respectively engaged with one of the gaps 612 and the notch 623. The other end of the locking plate 62 includes an engaging recess 625 and an engaging wall 624, the other pin 61 is engaged with the engaging recess 625 and the engaging wall 624 is engaged with a space between the two protrusions 611 to hold the two handles at the closed position as shown in FIG. 5C.

The pins 61 and the locking plate 62 involve complicate structure which is difficult to be fabricated and a higher manufacturing cost is expected which does not meet requirements in the market.

The present invention intends to provide a safety device for garden pruners and the device is easily to manufactured and operated.

### SUMMARY OF THE INVENTION

The present invention relates to pruners which comprises a first handle which is pivotably connected to a second handle. The first handle includes a first function member connected to a first end thereof and a second function member is connected to a first end of the second handle. The first and second handles are pivotably connected to each other. A first connection member is connected to an inside of the first handle and an end head is connected to a distal end of the first connection member. A second connection member is connected to an inside of the second handle and includes an outer threaded section. A collar is rotatably mounted to the first connection member and removably and threadedly connected to the outer threaded section of the second connection member.

The primary object of the present invention is to provide a safety device for positioning the two handles of pruners. The device includes a collar which is rotatably mounted to a first connection member on the first handle and removably connected to a second connection member on the second handle. The user simply rotates the collar to lock or unlock the safety device.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show pruners with the safety device of the present invention;

FIG. 2 is an exploded view to show the safety device of the present invention;

FIG. 3 is a cross sectional view to show that the collar is located in unlock position;

FIG. 4 is a cross sectional view to show that the collar is located in locked position;

FIG. 5A is an exploded view to show a conventional safety device for pruners;

FIG. 5B is a cross sectional view to show the conventional safety device, and

FIG. 5C shows that the conventional safety device is in locked position.

### DETAILED DESCRIPTION OF THE PREFERRED EMBODIMENT

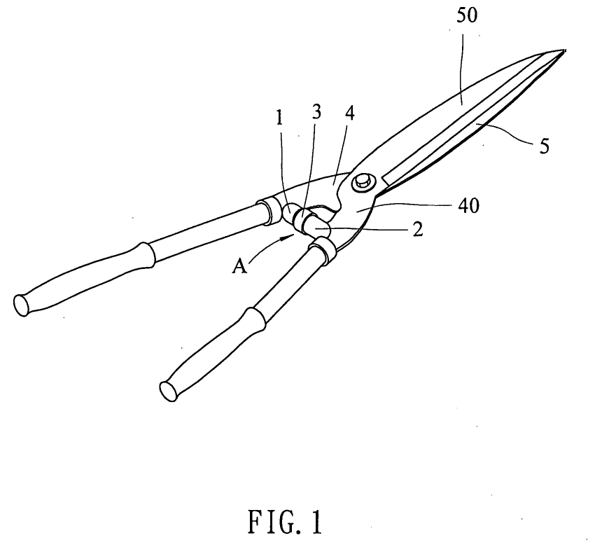

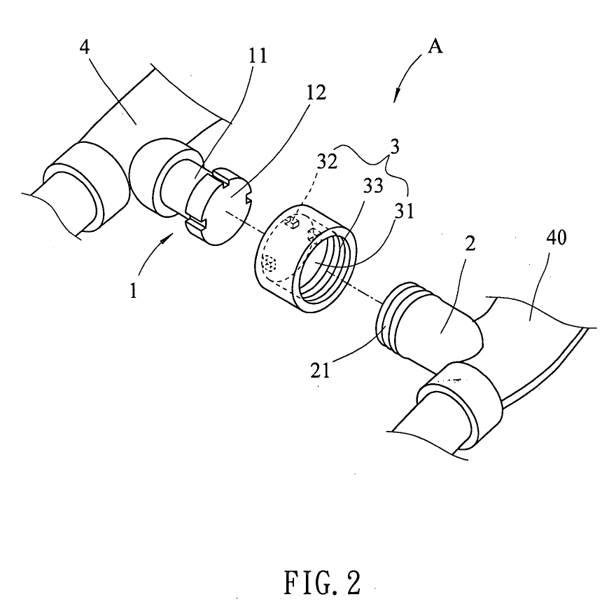

Referring to FIGS. 1 to 3, the pruners include a first handle 4 and a second handle 40. A first function member 5 is connected to a first end of the first handle 4 and a second function member 50 is connected to a first end of the second handle 40. The first and second handles 4, 40 are pivotably connected to each other by a pin.

A safety device “A” is connected between the first and second handles 4, 40. The safety device “A” includes a first connection member 1 connected to an inside of the first handle 4 and an end head 12 is connected to a distal end of the first connection member. The end head 12 includes a diameter which is larger than a diameter of the first connection member 1 so as to form a shrink neck portion 11. Three grooves 13 are defined axially through an outer periphery of the end head 12. The first handle 4 includes a first extension 41 extends from the inside thereof and the first connection member 1 includes a first recess 15 defined in an end thereof. The first extension 41 includes a first notch 411 defined in an outer periphery thereof and a first engaging hook 151 extends from an inner periphery of the first recess 15, the first engaging hook 151 is engaged with the first notch 411 so that the first extension 41 is securely engaged with the first recess 15.

A second connection member 2 is connected to an inside of the second handle 40 and includes an outer threaded section 21. The second handle 40 includes a second extension 410 extends from the inside thereof and the second connection member 2 includes a second recess 24 defined in an end thereof. The second extension 410 includes a second notch 4110 defined in an outer periphery thereof and a second engaging hook 241 extends from an inner periphery of the second recess 24. The second engaging hook 241 is engaged with the second notch 4110 so that the second extension 410 is securely engaged with the second recess 24.

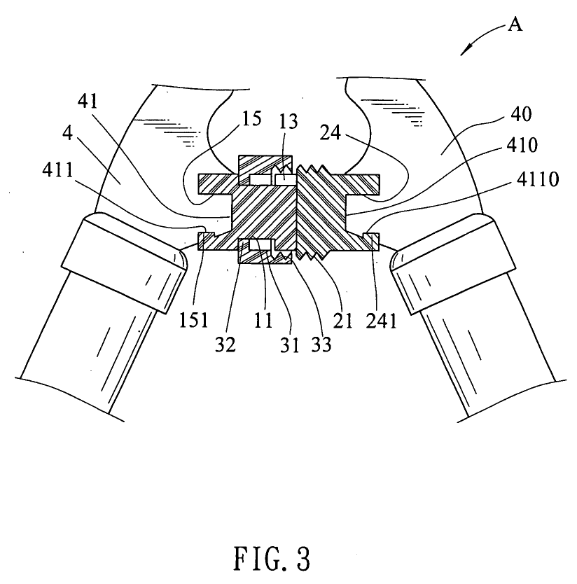

A collar 3 includes a through hole 31 and an inner threaded section 33. The collar 3 includes three protrusions 32 extending from an inner periphery thereof and the protrusions 32 are sized and located to pass through the grooves 14. A distance from an outside of each of the protrusions 32 to the inner periphery of the collar 3 in radial direction is shorter than the diameter of the end head 12. Therefore, the collar 3 is rotatably mounted to the first connection member 1 as shown in FIG. 3.

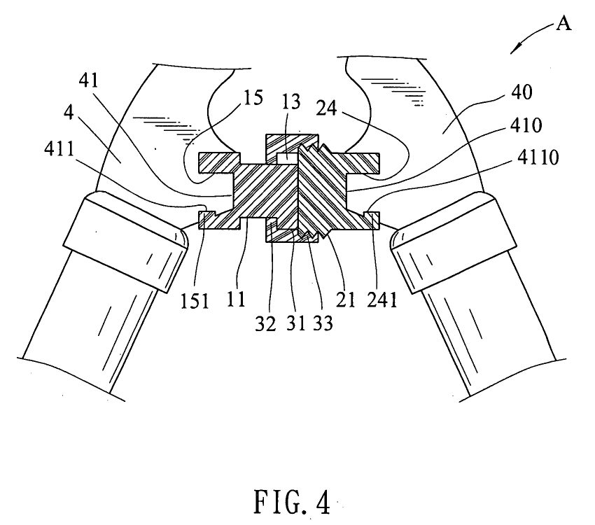

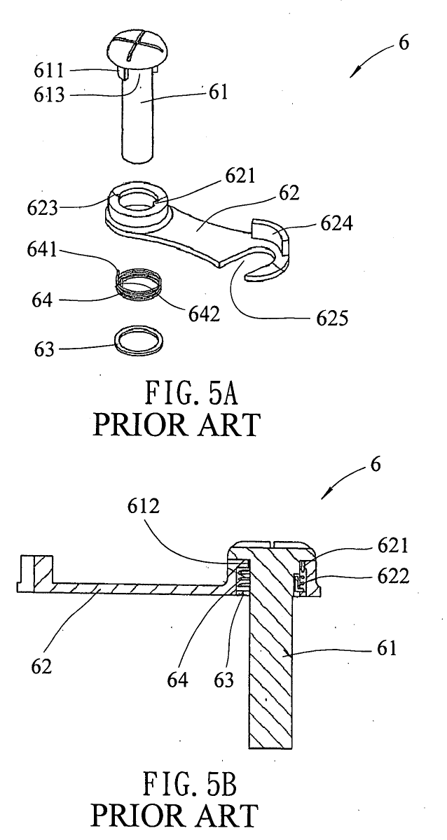

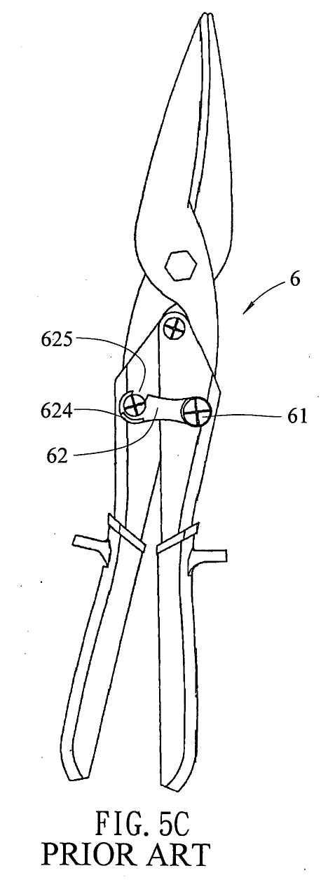

As shown in FIG. 4, when the pruners are not in use, the first and second handles 4, 40 are pulled toward each other and the collar 3 is moved toward the second connection member 2 and rotated to engage the inner threaded section 33 of the collar 3 with the outer threaded section 21 of the second connection member 2. The protrusions 32 are stopped by the end surface of the end head 12 as shown.

The shape of the collar 3 can be made to be polygonal or include serrated surface for convenience of operation by the users.

While we have shown and described the embodiment in accordance with the present invention, it should be clear to those skilled in the art that further embodiments may be made without departing from the scope of the present invention.

What is claimed is:

1. A pair of pruners comprising:
a first handle and a first function member connected to a first end of the first handle, a first connection member connected to an inside of the first handle and an end head connected to a distal end of the first connection member;
a second handle and a second function member connected to a first end of the second handle, the first and second handles pivotably connected to each other, a second connection member connected to an inside of the second handle, and
a collar rotatably mounted to the first connection member and removably connected to the outer threaded section of the second connection member.

2. The pruners as claimed in claim 1, wherein the end head includes a diameter which is larger than a diameter of the first connection member, at least one groove defined axially through an outer periphery of the end head, the collar includes at least one protrusion extending from an inner periphery thereof, the at least one protrusion is sized to pass through the at least one groove, a distance from an outside of the at least one protrusion to the inner periphery of the collar in radial direction is shorter than: the diameter of the end head.

3. The pruners as claimed in claim 1, wherein the first handle includes a first extension extends from the inside thereof and the first connection member includes a first recess defined in an end thereof, the first extension is securely engaged with the first recess.

4. The pruners as claimed in claim 3, wherein the first extension includes a first notch defined in an outer periphery thereof and a first engaging hook extends from an inner periphery of the first recess, the first engaging hook is engaged with the first notch.

5. The pruners as claimed in claim 1, wherein the second connection member includes an outer threaded section and the collar includes a through hole and an inner threaded section which is engaged with the outer threaded section of the second connection member.
